(19) United States
(12) Patent Application Publication
(10) Pub. No.: US 2013/0089232 A1
(43) Pub. Date: Apr. 11, 2013

(54) VOICE FILM OF MULTI-LAYERED STRUCTURE FOR FLAT TYPE SPEAKER

(71) Applicant: Dongman Kim, Seoul (KR)

(72) Inventor: Dongman Kim, Seoul (KR)

(73) Assignee: Exelway Inc., Seoul (KR)

(21) Appl. No.: 13/703,452

(22) PCT Filed: Jun. 7, 2011
(86) PCT No.: PCT/KR2011/004145

§ 371 Date: Dec. 11, 2012

(30) Foreign Application Priority Data
Jun. 11, 2010 (KR) 10-2010-0055203

(51) Int. Cl. H04R 7/04

(52) U.S. Cl. CPC H04R 7/04
USPC 381/431

(57) ABSTRACT

The present invention relates to a voice film having a multi-layered structure for a flat panel speaker, including a PCB configured to have permanent magnets disposed on the left and right sides thereof, to have a voice coil patterned therein and disposed between the permanent magnets on the left and right sides so that the voice coil is vibrated up and down, and to have a PCB structure of a stack structure and coil patterns formed on surfaces of the highest PCB, one or more intermediate layer PCBs, and the lowest PCB in the form of a consecutive spiral track, wherein the start points of coil patterns of adjacent PCBs formed in layers, from among the coil patterns, are shorted through a via hole and are bonded to the respective end points of the coil patterns of the adjacent PCBs at the end points of the coil patterns.

### CROSS REFERENCE TO RELATED APPLICATION

This application claims the benefit of Korean Patent Application No. 10-2010-55203, filed Nov. 6, 2010, which is hereby incorporated by reference in its entirety into this application.

### BACKGROUND OF THE INVENTION

1. Technical Field

The present invention relates generally to a flat panel type speaker and, more particularly, to a voice film for a flat panel type speaker having a multi-layered structure.

2. Description of the Related Art

A speaker includes a voice coil and a diaphragm interposed between magnets and generates a sound by a diaphragm that is vibrated when the voice coil moves.

The voice coil includes a circular voice coil and a straight type voice coil. The circular voice coil is used in a common circular speaker.

The straight type voice coil is shown in FIGS. 1 and 2. As shown in FIGS. 1 and 2, the straight type voice coil is wound in an elliptical form or printed in a pattern on one side or both sides of each of coil bases 11 and 21 each having a plate form.

The straight type voice coil of a winding form is wound over most of the regions of the coil base 11 or 21. If the coil base is ultra-small or large, some tension is generated and it is difficult o wind the straight type voice coil at a uniform interval. A difference between the tensions generates a difference between the resistances of internal coils, thereby becomes a deteriorating factor to generate a uniform sound.

For this reason, a straight type voice coil of a printed pattern form has recently been developed.

A conventional voice coil of a printed pattern form, however, is problematic in that it is difficult to apply to a high-capacity flat panel type speaker because a pattern is formed on one side or both sides of one Printed Circuit Board (PCB) and thus induced electromotive force cannot be increased.

### SUMMARY OF THE INVENTION

Accordingly, the present invention has been made keeping in mind the above problems occurring in the prior art, and an object of the present invention is to provide the voice film of a multi-layered structure for a flat panel speaker which can be used in a high-capacity speaker by increasing the number of turns of a coil or the magnetic flux density of the coil using a stack type PCB in order to increase the intensity of induced electromotive force.

In an aspect of the present invention, a voice film having a multi-layered structure for a flat panel speaker includes a PCB configured to have permanent magnets disposed on the left and right sides thereof, to have a voice coil patterned therein and disposed between the permanent magnets on the left and right sides so that the voice coil is vibrated up and down, and to have a PCB structure of a stack structure and coil patterns formed on surfaces of the highest PCB, one or more intermediate layer PCBs, and the lowest PCB in the form of a consecutive spiral track, wherein the start points of coil patterns of adjacent PCBs formed in layers, from among the coil patterns, are shorted through a via hole and are bonded to the respective end points of the coil patterns of the adjacent PCBs at the end points of the coil patterns.

In another aspect of the present invention, a voice film having a multi-layered structure for a flat panel speaker includes a PCB configured to have permanent magnets disposed on the left and right sides thereof, to have a voice coil patterned therein and disposed between the permanent magnets on the left and right sides so that the voice coil is vibrated up and down, and to have a PCB structure of a stack structure and coil patterns formed on surfaces of the highest PCB, one or more intermediate layer PCBs, and the lowest PCB in the form of a consecutive spiral track, so that an N-degree (N is an integer) layer is formed, wherein the coil patterns are shorted through via holes at the start points of coil patterns by an N/2-degree layer between adjacent PCBs and are bonded to the respective end points of coil patterns formed in N/2-degree layers of other adjacent PCBs at the end points of the coil patterns.

In yet another aspect of the present invention, a voice film having a multi-layered structure for a flat panel speaker includes a PCB configured to have permanent magnets disposed on the left and right sides thereof, to have a voice coil patterned therein and disposed between the permanent magnets on the left and right sides so that the voice coil is vibrated up and down, and to have a PCB structure of a stack structure and coil patterns formed on surfaces of the highest PCB, one or more intermediate layer PCBs, and the lowest PCB in the form of a consecutive spiral track, so that an N-degree (N is an integer) layer is formed, wherein adjacent coil patterns of the coil patterns are shorted through via holes at the start points of the coil patterns in pairs and are bonded to the respective end points of coil patterns of adjacent another pair of PCBs at the end points of the coil patterns.

In further yet another aspect of the present invention, a voice film having a multi-layered structure for a flat panel speaker includes a PCB configured to have permanent magnets disposed on the left and right sides thereof, to have a voice coil patterned therein and disposed between the permanent magnets on the left and right sides so that the voice coil is vibrated up and down, and to have a PCB structure of a stack structure and coil patterns formed on surfaces of the highest PCB, one or more intermediate layer PCBs, and the lowest PCB in the form of a consecutive spiral track, so that an N-degree (N is an integer) layer is formed, wherein the start points of coil patterns formed in two or more PCBs, from among the coil patterns, are shorted through via holes at the start points of the coil patterns, and the end points of the coil patterns formed in the respective PCBs are bonded to the end points of coil patterns formed on other adjacent PCBs.

It is preferred that the PCB layer having the stack structure be a 4-degree or higher layer.

It is preferred that each of the coil patterns includes straight type pattern parts arranged in parallel and curved pattern parts each configured to couple the straight type pattern parts.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an example of a cross section of a conventional voice film for a flat panel speaker;

FIG. 2 shows another example of a cross section of a conventional voice film for a flat panel speaker;

FIG. 3 is a schematic diagram showing a flat panel type speaker to which the voice film of a multi-layered structure for a flat panel speaker in accordance with the present invention is applied;

FIG. 4 is a perspective view of a voice film having a multi-layered structure for a flat panel speaker in accordance with the present invention;

FIG. 5 is a cross-sectional view taken along line A-A of FIG. 4 and is a cross-sectional view of a voice film having a multi-layered structure for a flat panel speaker in accordance with a first embodiment of the present invention;

FIG. 6 is a cross-sectional view taken along line A-A of FIG. 4 and is a cross-sectional view of a voice film having a multi-layered structure for a flat panel speaker in accordance with a second embodiment (e.g., a 4-degree layer structure) of the present invention;

FIG. 7 is a cross-sectional view taken along line A-A of FIG. 4 and is a cross-sectional view of a voice film having a multi-layered structure for a flat panel speaker in accordance with the second embodiment (e.g., a 6-degree layer structure) of the present invention;

FIG. 8 is a cross-sectional view taken along line A-A of FIG. 4 and is a cross-sectional view of a voice film having a multi-layered structure for a flat panel speaker in accordance with a third embodiment (e.g., a 6-degree layer structure) of the present invention; and

FIG. 9 is a cross-sectional view taken along line A-A of FIG. 4 and is a cross-sectional view of a voice film having a multi-layered structure for a flat panel speaker in accordance with a fourth embodiment (e.g., a 4-degree layer structure) of the present invention.

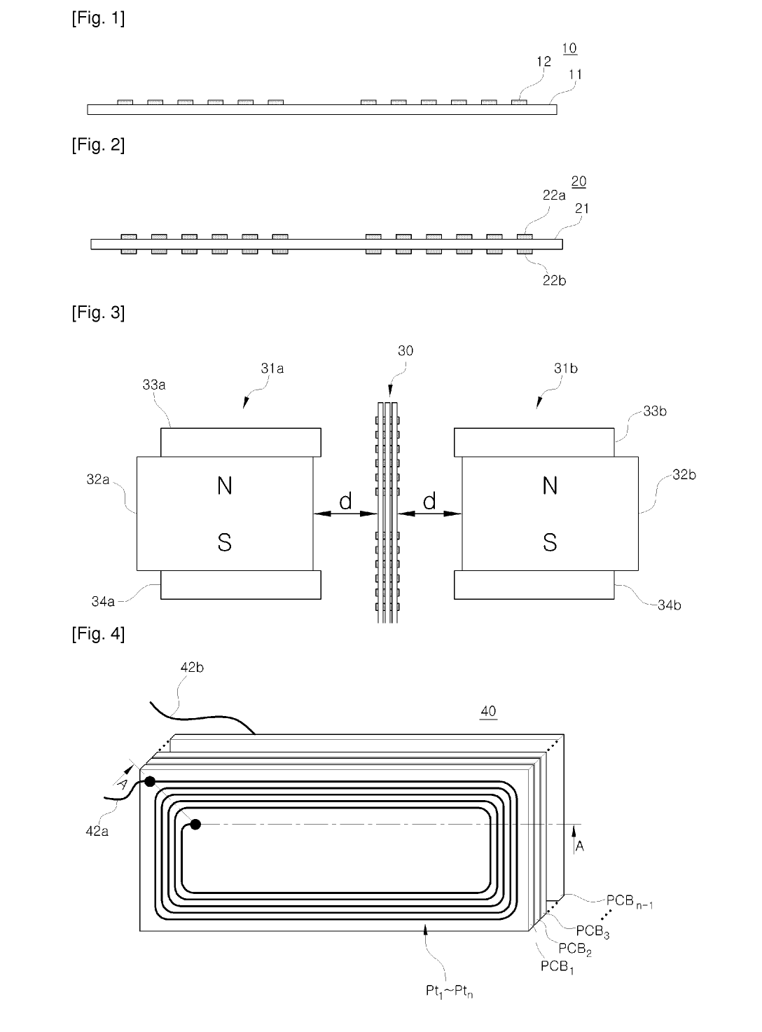

### DESCRIPTION OF THE PREFERRED EMBODIMENTS

The structures and acting effects of the voice films of multi-layered structures for flat panel speakers in accordance with some embodiments of the present invention are described below with reference to the accompanying drawings.

FIG. 3 is a schematic diagram showing a flat panel type speaker to which the voice film of a multi-layered structure for a flat panel speaker in accordance with the present invention is applied.

The flat panel type speaker to which the voice film of the present invention is applied is shown in FIG. 3. The flat panel type speaker includes a pair of magnetic bodies 31a and 31b spaced apart from each other at a specific interval and configured to face each other and a voice film 30 interposed between the pair of magnetic bodies 31a and 31b.

The pair of magnetic bodies 31a and 31b that face each other has the same construction and may have permanent magnets 32a and 32b, upper yorks 33a and 33b placed at the tops of the permanent magnets 32a and 32b, and lower yorks 34a and 34b placed at the bottom of the permanent magnets 32a and 32b, respectively.

The permanent magnets 32a and 32b included within the magnetic bodies 31a and 31b that face each other preferably have opposite polarities so that an attractive force is applied between the permanent magnets 32a and 32b. The voice film 30 preferably is spaced apart from each of the magnetic bodies 31a and 31b on both sides thereof at the same distance d so that the same magnetic force is applied to the voice film 30.

FIG. 4 is a perspective view of a voice film having a multi-layered structure for a flat panel speaker in accordance with the present invention.

As shown in FIG. 4, the voice film 40 of a multi-layered structure in accordance with the present invention may include PCBs PCB₁ to PCBₙ₋₁ and coil patterns Pt₁ to Ptₙ. A first power source line 42a may be connected to the start point of the coil pattern Pt₁ of the highest PCB PCB₁, and a second power source line 42b can be connected to the end point of the coil pattern Ptₙ of the lowest PCB PCBₙ₋₁.

The PCBs PCB₁ to PCBₙ₋₁ are plates and may be made of insulating material, such as polyimide.

The coil patterns Pt₁ to Ptₙ may be formed on surfaces of the highest PCB PCB₁, the lowest PCB PCBₙ₋₁, and the intermediate layer PCBs PCB₂ to PCBₙ₋₂.

The coil patterns Pt₁ to Ptₙ are printed in a spiral track form, and they may have a plurality of straight-line pattern parts and a plurality of curved pattern parts which are not disconnected one another.

Furthermore, the coil patterns Pt₁ to Ptₙ may be formed to have a uniform line width or may be formed to have different line widths on a line that is symmetrical with a coil pattern formed on another surface although the coil patterns Pt₁ to Ptₙ are formed on the same surface. Here, the line width between the coil patterns may be changed by taking the area of the PCBs PCB₁ to PCBₙ₋₁ and the magnetic force of the magnetic bodies into consideration.

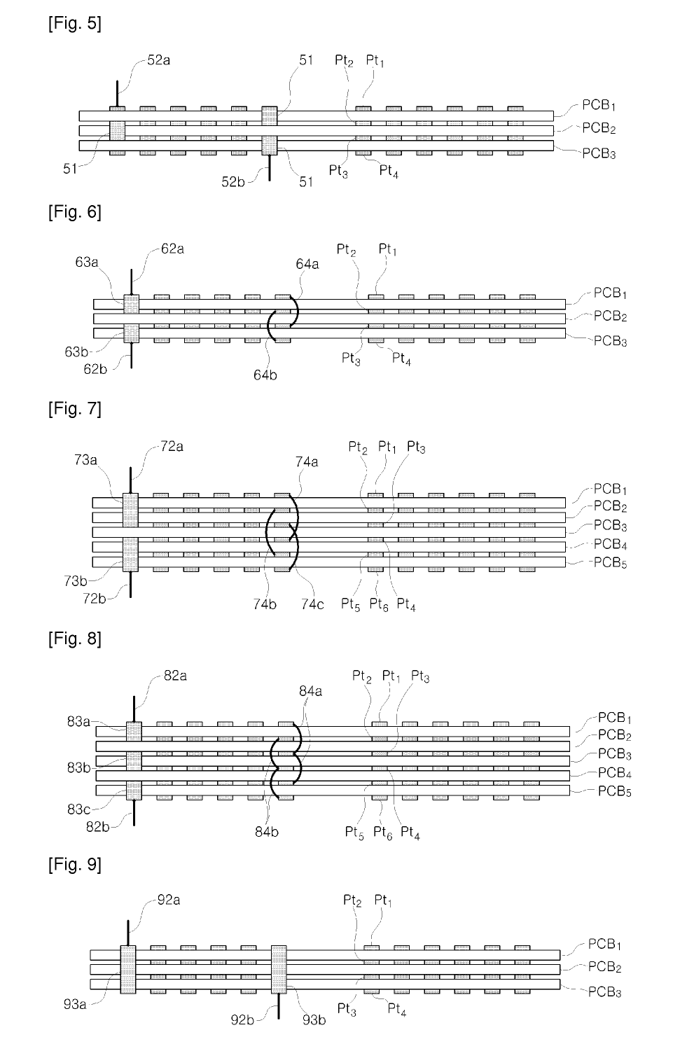

The structures of the voice film 40 of a multi-layered structure shown in FIG. 4 in accordance with the present invention are described with reference to FIGS. 5 to 9 showing cross sections taken along line A-A.

FIG. 5 is a cross-sectional view taken along line A-A of FIG. 4 and is a cross-sectional view of a voice film having a multi-layered structure for a flat panel speaker in accordance with a first embodiment of the present invention.

The first embodiment of the present invention relates to the cross-sectional view of a voice film having a 4-degree layer structure. The coil patterns Pt₁ to Pt₄ are formed from the start point of the coil pattern Pt₁ on a surface of the highest PCB PCB₁ to the end point of the coil pattern Pt₄ on a surface of the lowest PCB PCB₃ via an intermediate layer PCB PCB₂ (through a connection groove 51).

A first power source line 52a may be connected to the start point of the coil pattern Pt₁, and the second power source line 52b may be connected to the end point of the coil pattern Pt₄.

This structure may also be applied to a voice film having a PCB structure of 6 layers or higher. This structure is advantageous in that it can be applied to a high-capacity speaker because induced electromotive force can be increased by increasing the number of turns.

FIG. 6 is a cross-sectional view taken along line A-A of FIG. 4 and is a cross-sectional view of a voice film having a multi-layered structure for a flat panel speaker in accordance with a second embodiment (e.g., a 4-degree layer structure) of the present invention, and FIG. 7 is a cross-sectional view taken along line A-A of FIG. 4 and is a cross-sectional view of a voice film having a multi-layered structure for a flat panel speaker in accordance with the second embodiment (e.g., a 6-degree layer structure) of the present invention.

The second embodiment of the present invention of FIGS. 6 and 7 has a structure in which coil patterns are shorted by an N/2 degree and coil patterns are bonded in a voice film having an N-degree (N is an integer) layer structure.

FIG. 6 is a cross-sectional view of the voice film having a 4-degree layer structure (including 3 PCBs PCB₁ to PCB₃). Coil patterns Pt₁ and Pt₂ are shorted through via holes 63a and 63b at the start point of the pattern, and likewise the coil patterns Pt₃ and Pt₄ are shorted through the via holes at the start point of the coil pattern. The end point of the first coil pattern Pt₁ is bonded (64a) to the end point of the third coil pattern Pt₃, and the end point of the second coil pattern Pt₂ is bonded (64b) to the end point of the fourth coil pattern Pt₄.

A first power source line 62a may be connected to the start point of the first coil pattern Pt₁, and a second power source line 62b may be connected to the start point of the fourth coil pattern Pt₄.

FIG. 7 is a cross-sectional view of the voice film having a 6-degree layer structure (including 5 PCBs PCB₁ to PCB₅). Coil patterns Pt₁ to Pt₃ are shorted through a via hole 73a at the start point of the coil pattern, and likewise coil patterns Pt₄ to Pt₆ are shorted through a via hole 73b at the start point of the coil pattern. The end point of the first coil pattern Pt₁ is bonded (74a) to the end point of the fourth coil pattern Pt₄, and the end point of the second coil pattern Pt₂ is bonded (74b) to the end point of the fifth coil pattern Pt₅, and the end point of the third coil pattern Pt₃ is bonded (74c) to the end point of the sixth coil pattern Pt₆.

A first power source line 72a may be connected to the start point of the first coil pattern Pt₁, and the second power source line 72b may be connected to the start point of the sixth coil pattern Pt₆.

This structure may also be applied to a voice film having a PCB structure of 8 layers or higher. This structure is advantageous in that it can be applied to a high-capacity speaker because induced electromotive force can be increased by increasing the number of turns.

FIG. 8 is a cross-sectional view taken along line A-A of FIG. 4 and is a cross-sectional view of a voice film having a multi-layered structure for a flat panel speaker in accordance with a third embodiment (e.g., a 6-degree layer structure) of the present invention.

FIG. 8 is a cross-sectional view of the voice film having a 6-degree layer structure (including 5 PCBs PCB₁ to PCB₅). Coil patterns Pt₁ to Pt₆ are shorted in pair (e.g., Pt₁ and Pt₂) through via holes 83a, 83b, and 83c at the start point of the coil pattern, the end points of the first, third, and fifth coil patterns Pt₁, Pt₃, and Pt₅ are bonded together (84a), and the end points of the second, fourth, and sixth coil patterns Pt₂, Pt₄, and Pt₆ are bonded together (84b).

A first power source line 82a may be connected to the start point of the first coil pattern Pt₁, and a second power source line 82b may be connected to the start point of the sixth coil pattern Pt₆.

This structure may also be applied to a voice film having a PCB structure of 8 layers or higher. This structure is advantageous in that it can be applied to a high-capacity speaker because induced electromotive force can be increased by increasing the number of turns.

FIG. 9 is a cross-sectional view taken along line A-A of FIG. 4 and is a cross-sectional view of a voice film having a multi-layered structure for a flat panel speaker in accordance with a fourth embodiment (e.g., a 4-degree layer structure) of the present invention.

FIG. 9 is a cross-sectional view of the voice film having a 4-degree layer structure (including 3 PCBs PCB₁ to PCB₃). All coil patterns Pt₁ to Pt₄ are shorted through a via hole 93a at the start point of the pattern and are bonded through a via hole 93b at the end point of the pattern of the coil patterns Pt₁ to Pt₄.

A first power source line 92a may be connected to the start point of the shorted coil pattern, and the second power source line 92b may be connected to the end point of the bonded coil pattern.

The embodiment of FIG. 9 illustrates that all the coil patterns Pt₁ to Pt₄ are shorted, but the construction of the present invention can be embodied by shorting the first and fourth layers directly without shorting the second and third layers according to circumstances.

This structure may also be applied to a voice film having a PCB structure of 6 layers or higher. This structure is advantageous in that it can have the same performance as that when a Litz wire is wound and it can be applied to a high-capacity speaker because induced electromotive force can be increased by increasing the number of turns.

In accordance with the constructions of the present invention, there can be provided a voice film having a multi-layered structure for a flat panel speaker which can be used in a high-capacity speaker by increasing the number of turns of a coil or the magnetic flux density of the coil using a stack type PCB in order to increase the intensity of induced electromotive force.

While some embodiments of the invention have been described with reference to the accompanying drawings, it will be understood that those skilled in the art can implement the technical construction of the present invention in various forms without departing from the technical spirit or indispensable characteristics of the present invention. Accordingly, the above embodiments should be construed to be illustrative and should not be limitative from all aspects. Furthermore, the scope of the present invention is defined by the appended claims rather than the above detailed description. The present invention should be construed to cover all modifications or variations induced from the meanings and scope of the appended claims and their equivalents.

1. A voice film having a multi-layered structure for a flat panel speaker, wherein:
the voice film has a Printed Circuit Board (PCB) structure of a stack structure,
coil patterns of a consecutive spiral track form are formed on surfaces of a highest PCB, one or more intermediate layer PCBs, and a lowest PCB, and
the coil patterns formed in each layer are bonded together through a via hole of an adjacent PCB.

2. A voice film having a multi-layered structure for a flat panel speaker, wherein:
the voice film has a Printed Circuit Board (PCB) structure of a stack structure,
coil patterns formed on surfaces of a highest PCB, one or more intermediate layer PCBs, and a lowest PCB in a consecutive spiral track form, so that an N-degree (N is an integer) layer is formed,
wherein the coil patterns are shorted through via holes at start points of coil patterns by an N/2-degree layer between adjacent PCBs and are bonded to respective end points of coil patterns formed in N/2-degree layers of other adjacent PCBs at the end points of the coil patterns.

3. A voice film having a multi-layered structure for a flat panel speaker, wherein:
the voice film has a Printed Circuit Board (PCB) structure of a stack structure,
coil patterns formed on surfaces of a highest PCB, one or more intermediate layer PCBs, and a lowest PCB in a consecutive spiral track form, so that an N-degree (N is an integer) layer is formed,
wherein adjacent coil patterns of the coil patterns are shorted through via holes at start points of the coil patterns in pairs and are bonded to respective end points of coil patterns of adjacent another pair of PCBs at the end points of the coil patterns.

4. A voice film having a multi-layered structure for a flat panel speaker, wherein:
the voice film has a Printed Circuit Board (PCB) structure of a stack structure,
coil patterns formed on surfaces of a highest PCB, one or more intermediate layer PCBs, and a lowest PCB in a consecutive spiral track form, so that an N-degree (N is an integer) layer is formed,
wherein start points of coil patterns formed in two or more PCBs, from among the coil patterns, are shorted through via holes at start points of the coil patterns, and end points of the coil patterns formed in the respective PCBs are bonded to end points of coil patterns formed on other adjacent PCBs.

5. The voice film according to claim 1, wherein the PCB layer having the stack structure is a 4-degree or higher layer.

6. The voice film according to claim 1, wherein each of the coil patterns comprises:
straight type pattern parts arranged in parallel, and
curved pattern parts each configured to couple the straight type pattern parts.

7. The voice film according to claim 2, wherein the PCB layer having the stack structure is a 4-degree or higher layer.

8. The voice film according to claim 3, wherein the PCB layer having the stack structure is a 4-degree or higher layer.

9. The voice film according to claim 4, wherein the PCB layer having the stack structure is a 4-degree or higher layer.
